(19) United States
(12) Patent Application Publication
(10) Pub. No.: US 2013/0219423 A1
(43) Pub. Date: Aug. 22, 2013

(54) Algorithmic Media Stream Selection

(71) Applicants: David B. Prickett, San Diego, CA (US); Wendell Sun, San Diego, CA (US); Kevin S. Wirick, Olivenhain, CA (US); Mark S. Griffiths, Manhattan Beach, CA (US)

(72) Inventors: David B. Prickett, San Diego, CA (US); Wendell Sun, San Diego, CA (US); Kevin S. Wirick, Olivenhain, CA (US); Mark S. Griffiths, Manhattan Beach, CA (US)

(73) Assignee: General Instrument Corporation, Horsham, PA (US)

(21) Appl. No.: 13/397,774

(22) Filed: Feb. 16, 2012

(51) Int. Cl. H04N 21/25

(52) U.S. Cl. 725/32

(57) ABSTRACT

In embodiments of algorithmic media stream selection, a media routing device (120) receives media content (106) from a content distributor (202) and streams the media content to a media playback device (122). The media routing device can receive a request for a media content stream (110) from the media playback device, and select a substitute media content stream (112) for distribution to the media playback device based on one or more variable parameters. The media routing device then forwards the request to the content distributor for the substitute media content stream, and receives the substitute media content stream from the content distributor. The media routing device is implemented to then identify the substitute media content stream as the requested media content stream, and communicate the substitute media content stream to the media playback device for playback as the requested media content stream.

### BACKGROUND

The traditional notion of watching television at home has evolved into many different forms of viewing television content, on many different devices. For example, users can watch television content, such as live television, recorded television, and time-shifted programs and movies, on various devices, such as televisions, display devices, entertainment devices, computers, and even mobile devices, such as tablets and mobile phones. Media content, such as streaming live television or recorded media content, can be streamed or otherwise communicated to multiple client devices for audio/video playback of the media content on the client devices. However, there can be media content distribution limitations, such as available bandwidth for a household system that may include several different types of client devices implemented to receive streaming media content, such as for television content viewing.

### BRIEF DESCRIPTION OF THE DRAWINGS

Embodiments of algorithmic media stream selection are described with reference to the following Figures. The same numbers may be used throughout to reference like features and components that are shown in the Figures:

FIG. 1 illustrates an example system in which embodiments of algorithmic media stream selection can be implemented.

FIG. 2 further illustrates the example system in which embodiments of algorithmic media stream selection can be implemented.

FIG. 3 illustrates example method(s) of an algorithmic media stream selection in accordance with one or more embodiments.

FIG. 4 illustrates example method(s) of an algorithmic media stream selection in accordance with one or more embodiments.

FIG. 5 illustrates various components of an example electronic device that can implement embodiments of algorithmic media stream selection.

### DETAILED DESCRIPTION

In embodiments, algorithmic media stream selection can be implemented to balance distribution of streaming media content in a household or business environment that may include several different types of media playback devices receiving streaming media content, such as for television content viewing. For example, a household DSL (digital subscriber line) system may be limited to two standard definition services, one or two high-definition services, and have a combined total bandwidth limitation. Further, the different types of media playback devices may each have different bandwidth limitations, and/or standard definition or high definition playback capabilities. For example, a household or business environment may include a television set-top box, a computer device, and a mobile device that are all utilized to playback television media content for viewing. In an embodiment, algorithmic media stream selection is implemented to determine an overall available bitrate for a household or business environment, and make a determination as to whether lower bitrate media content streams can be substituted for higher bitrate media content streams.

While features and concepts of algorithmic media stream selection can be implemented in any number of different devices, systems, configurations, and/or networks, embodiments of algorithmic media stream selection are described in the context of the following example devices, systems, and methods.

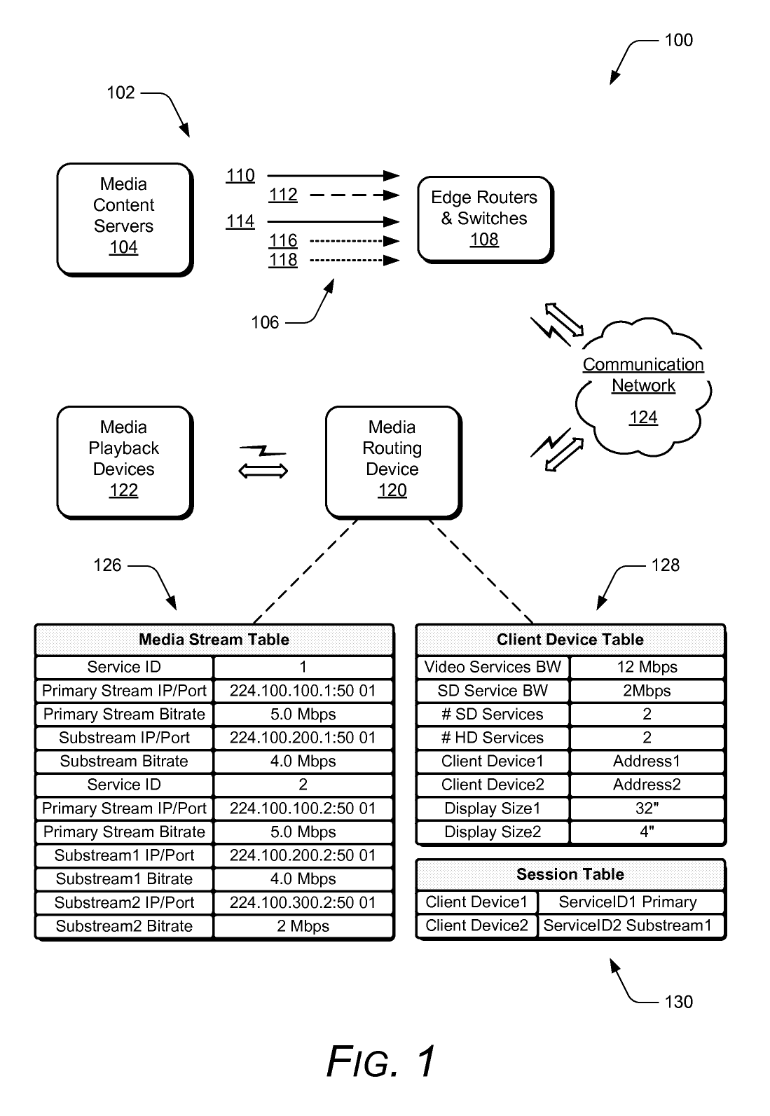

FIG. 1 illustrates an example media routing system 100 in which embodiments of algorithmic media stream selection can be implemented. In the example system, a media content distribution system 102 includes media content servers 104 that distribute streams of media content 106 out to edge routers and/or switches 108. The media content distribution system 102 may be commonly referred to as a headend that distributes the media content 106 via a cable television system or as multicast IP (e.g., also commonly referred to as broadband television, or as Internet television). A television channel, also referred to herein as a service, may be distributed as multiple media content streams at differing bitrates to accommodate different client device system download parameters, such as available bandwidth, standard definition or high definition playback capabilities, and/or the number of media content streams that are currently streaming in a household or business environment. In this example, the media content 106 is shown as media content streams and substreams, such as media content stream 110 and associated substream 112, and as media content stream 114 and associated substreams 116 and 118.

The example media routing system 100 also includes a media routing device 120 that can be implemented in a household or business environment. The media routing device receives the media content 106 from the media content distribution system and communicates the media content to one or more media playback devices 122. The media playback devices can include any one or combination of a communication, computer, playback, gaming, entertainment, and/or electronic device, such as a mobile phone or tablet device that can be configured as a television client device to receive and playback media content. For example, a household or business environment may include a television set-top box, a computer device, and a mobile device that are all utilized to playback television media content for viewing. Further, the media routing device 120 may be implemented as an integrated component or device of a television set-top box or a computer device in a household or business environment.

In implementations, the edge routers and switches 108, the media routing device 120, and the media playback devices support the Internet Group Management Protocol (IGMP) and Multicast Listener Discovery (MLD) for IPv6 for IP-based communications between the devices. Additionally, any of the devices and servers can communicate via a communication network 124, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

In an example system implementation, the media routing device 120 initializes, or otherwise boots-up in the system, and is provisioned with a media stream table 126, in which the list of multiple-versioned media content streams is maintained. For example, the media stream table includes a first service identifier that correlates to the media content stream 110 and associated substream 112, identified as the primary stream and substream for Service ID 1. The media stream table also includes a second service identifier that correlates to the media content stream 114 and associated substreams 116 and 118, identified as the primary stream, substream1, and substream2 for Service ID 2. The media stream table also includes the stream bitrate, IP address, and port ID that is associated with each of the primary streams and substreams of the media content.

After the media routing device 120 is initialized and provisioned with the media stream table 126, the media routing device 120 is implemented to provision and/or discover the one or more media playback devices 122, and create a entry for each of the media playback devices in a client device table 128. The client device table includes subscriber-specific parameters of the media playback devices and the overall household or business environment that includes the media playback devices. For example, the client device table 128 includes the video services bandwidth for the overall environment, the standard definition (SD) service bandwidth, the number of standard definition services, and the number of high-definition (HD) services. The example client device table 128 also includes identifiers of the client devices (e.g., media playback devices 122) that are registered with the media routing device 120, as well as the display size for each of the registered client devices, such as a DVR, a television, and a mobile phone. For example, a first client device is a thirty-two inch (32″) television display device and a second client device has a four inch (4″) display screen, such as a mobile phone with an integrated display screen. The client devices can be identified in the client device table by a MAC address and/or an IP address.

In embodiments, the media routing device 120 can also include a session table 130 that correlates a particular client device, as identified in the client device table 128, with the current media content stream, as identified in the media stream table 126. For example, the session table 130 identifies that the first client device is receiving the primary media content stream of the first service, and the second client device is receiving the first media content substream of the second service.

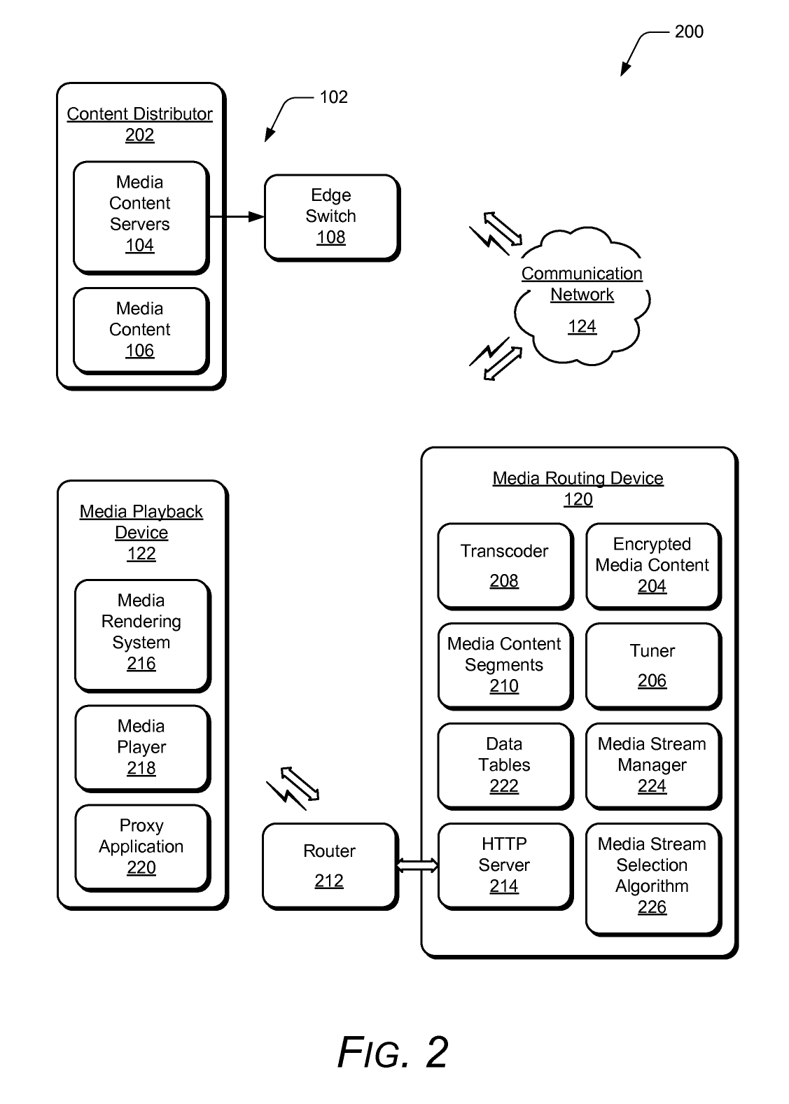

FIG. 2 illustrates an example media routing system 200 that includes the servers and devices described with reference to FIG. 1, and in which embodiments of algorithmic media stream selection can be implemented. The example system 200 includes a content distributor 202 in the media content distribution system 102. The content distributor 202 includes the media content servers 104 to distribute the media content 106, such as live television and/or recorded on-demand video content, to the media routing device 120 via an edge switch 108 and the communication network 124. The media routing device 120 may also receive media content and data from other media content sources and/or services, such as an encryption key service that distributes content encryption keys for secure delivery and communication of encrypted media content in the example media routing systems.

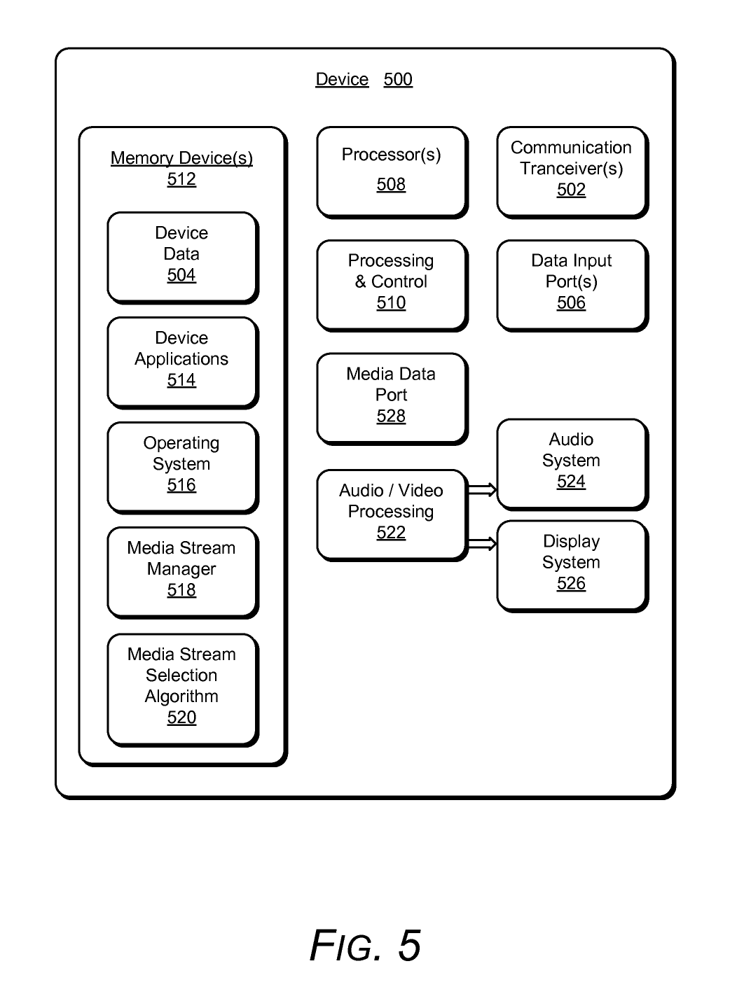

The content distributor 202 and/or the media content servers 104 can be implemented with various components, such as processor and memory devices, as well as with any combination of differing components as further described with reference to the example electronic device shown in FIG. 5. For example, the content distributor includes storage media, such as any type of memory and/or suitable electronic data storage, to store or otherwise maintain the media content and other data.

As described above, the media routing device 120 can be implemented as an independent device (e.g., as shown), or may be implemented as an integrated component or device of a computer device or television client device, such as a television set-top box or digital video recorder (DVR). Alternatively, the media routing device may be implemented as a network-based media content server (e.g., in the cloud) to implement embodiments of algorithmic media stream selection as described herein. Additionally, the media routing device 120 can be implemented with various components, such as processor and memory devices, as well as with any combination of differing components as further described with reference to the example electronic device shown in FIG. 5.

In this example system 200, the media routing device 120 receives the media content 106 from the media content distribution system 102 as encrypted media content 204, which can include any type of audio, video, and/or image data in the form of television programming, movies, on-demand video, interactive games, advertisements, and the like. In an implementation of a television client device, the media routing device 120 can include a tuner 206 that tunes to a television channel frequency over which the media content is delivered. The media routing device may also include a transcoder 208 to transcode or otherwise reformat media content segments 210 of the media content 204 for distribution to the media playback device 122. In a DVR or recording implementation, the media routing device may record the encrypted media content into memory that maintains the recorded media content.

The media routing device is implemented to communicate the media content to the media playback device 122 via a router 212 implemented for wired and/or wireless communication. For example, the media content can be communicated to the media playback device 122 as the media content segments 210 with an HTTP server 214 via the router 212. The media content may also be communicated as the encrypted media content 204 via the router 212, so that the media content remains secure when communicated over wired or wireless communication links to the media playback device.

As described above, the media playback device 122 may be implemented as any one or combination of a communication, computer, playback, gaming, entertainment, and/or electronic device, such as a mobile phone or tablet device that can be configured as a television client device to receive and playback media content. Additionally, the media playback device can be implemented with various components, such as processor and memory devices, as well as with any combination of differing components as further described with reference to the example electronic device shown in FIG. 5. For example, the media playback device includes a media rendering system 216 to playback media content for viewing on an integrated display screen of the device.

The media playback device 122 can also include various client applications, such as a media player 218 that is implemented to manage media content playback at the device. The media playback device may also include a proxy application 220 that can be implemented as a software application, and executed by processors on the device, to interface the media player 218 with the media routing device 120. In implementations, the proxy application can also instantiate the media player for media content playback at the media playback device.

In the example system 200, the media routing device 120 is shown to include the data tables 222 (e.g., the media stream table 126, the client device table 128, and the session table 130 described with reference to FIG. 1). The media routing device also includes a media stream manager 224 that can be implemented as computer-executable instructions, such as a software application, and executed by processors on the device to implement embodiments of algorithmic media stream selection.

In embodiments, the media stream manager 224 at the media routing device 120 can receive a request for a media content stream from the media playback device 122. In implementations, the devices utilize the Internet Group Management Protocol (IGMP) for IP-based communications between the devices, and the media content 106 is available from the media content distribution system 102 as multicast IP media streams. Accordingly, the request for the media content stream from the media playback device is a request to join an IP multicast group that corresponds to the requested media content stream (i.e., an IGMP membership report to join the requested IP address). The media stream manager 224 can then initiate a media stream selection algorithm 226 to determine whether to substitute the requested media content stream with a slower bitrate media content stream. For example, referring to the media stream table 126 described with reference to FIG. 1, the primary stream bitrate is 5.0 Mbps for the primary stream of Service ID 1, which correlates to the media content stream 110. The media stream selection algorithm 226 can be utilized to determine whether to substitute the requested media content stream (e.g., the primary stream of Service ID 1) with the substream of Service ID 1, which correlates to the media content substream 112 and has a bitrate of 4.0 Mbps.

The media stream selection algorithm 226 can be implemented based on any variable parameters of a media routing system, such as the available distribution bandwidth in a system that includes the media playback device, a size of a display of the media playback device, a number of media content streams that are currently streaming to one or more media playback devices in the system, or even a time of day. In embodiments, a multicast substitution can be based on any defined algorithm and/or based on any variable parameters of a media routing system. In an implementation, the media stream selection algorithm 226 is utilized to determine the bitrate that is available for a high definition (HD) service, such as when the media playback device 122 requests a media content stream. The available bitrate can be determined from the following equation:

$${Bitrate}_{HDSvc} < \frac{{Bitrate}_{VideoSvc} - ( \# SD Svc * {Bitrate}_{SDSvc} )}{\# HD Svc}$$

where:
the Bitrate_{VideoSvc} is the total household bitrate in terms of available bandwidth;
the #SD Svc is the number of standard definition services allocated for the household (e.g., an environment);
the Bitrate_{SDSvc} is the bitrate of the standard definition services; and
the #HD Svc is the number of high definition services allocated for the household.

### Additionally:

### if ([Bitrate]HDSvc>[Bitrate]STBTVSize),

then Bitrate_{HDSvc}=Bitrate_{STBTVSize}.

In an example application of the media stream selection algorithm 226 to determine an available bitrate of 4.0 Mbps, and referring to the media stream table 126 and the client device table 128 described with reference to FIG. 1, the equation can be applied with the following parameters:

$${Bitrate}_{HDSvc} \leq \frac{12 Mbps ( 2 * 2 Mbps )}{2} = 4 Mbps$$

Based on the bitrate determination of 4.0 Mbps, the media stream manager 224 can select a substitute media content stream to replace the requested media content stream for distribution to the media playback device 122. For example, the requested media content stream 110 that has a bitrate of 5.0 Mbps (e.g., the primary stream of Service ID 1 shown in the media stream table 126) can be substituted with the substream 112 of Service ID 1, which has a bitrate of 4.0 Mbps. In this example, the substitute media content stream 112 has a lower bitrate than the requested media content stream 110, and the media stream manager 224 selects the substitute media content stream for distribution to the media playback device based on the lower bitrate.

The media stream manager 224 is implemented to then replace the destination multicast IP address of the requested media content stream with a substitute destination multicast IP address that corresponds to the substitute media content stream, and forward the substitute destination multicast IP address to the media content distribution system 102 as a request for the substitute media content stream. When the substitute media content stream is received from the content distribution system, the media stream manager 224 can identify, or otherwise update, the substitute media content stream with the destination multicast IP address that corresponds to the originally requested media content stream. The media routing device 120 then communicates the substitute media content stream (e.g., the media content segments 210 of the media content) that is identified with the destination multicast IP address of the requested media content stream to the media playback device 122 for playback as the requested media content stream. From a perspective of the media playback device, the media content stream that was requested has been delivered according to the destination multicast IP address associated with the media content segments, even though the media playback device receives the substitute media content stream for playback.

Additionally, the media routing device 120 may receive a status query from the media content distribution system 102 (e.g., from the edge switch 108) for playback status of the substitute media content stream that is streaming to the media playback device 122. The status query can be communicated as an IGMP membership query for keep alive status to maintain the session. The media stream manager 224 then updates the status query with the IP address that corresponds to the originally requested media content stream, and forwards the updated status query to the media playback device. The media stream manager can receive a status report back from the media playback device, such as an IGMP report, update the status report with the IP address that corresponds to the substitute media content stream, and forward the updated status report to the content distribution system in response to the status query.

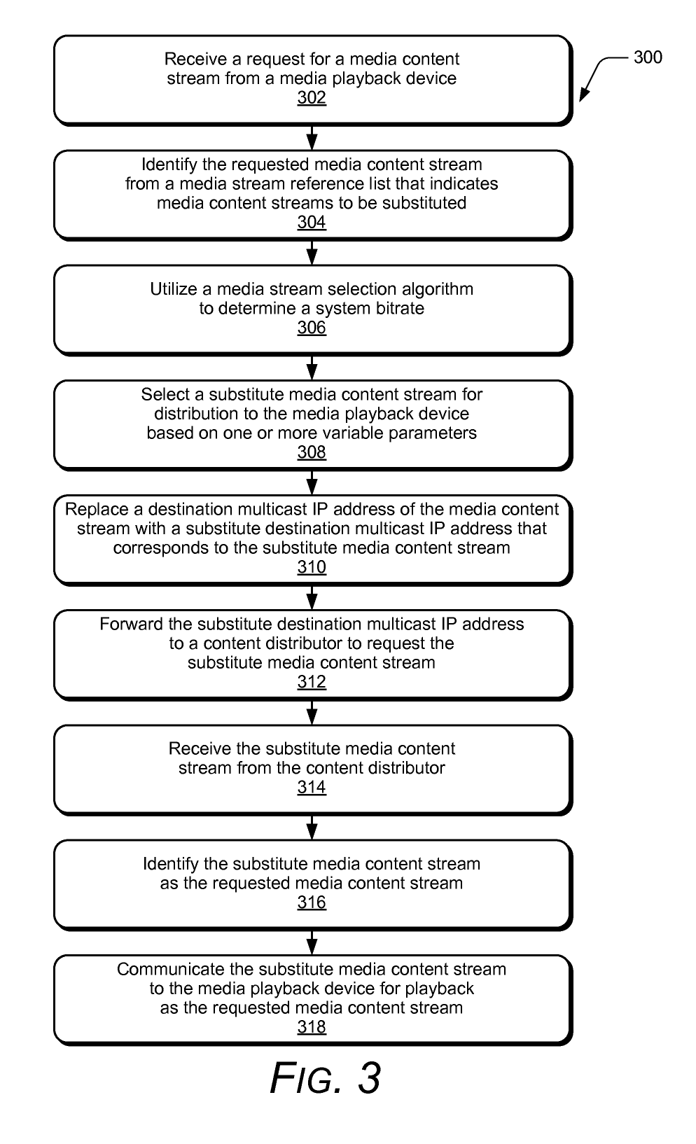

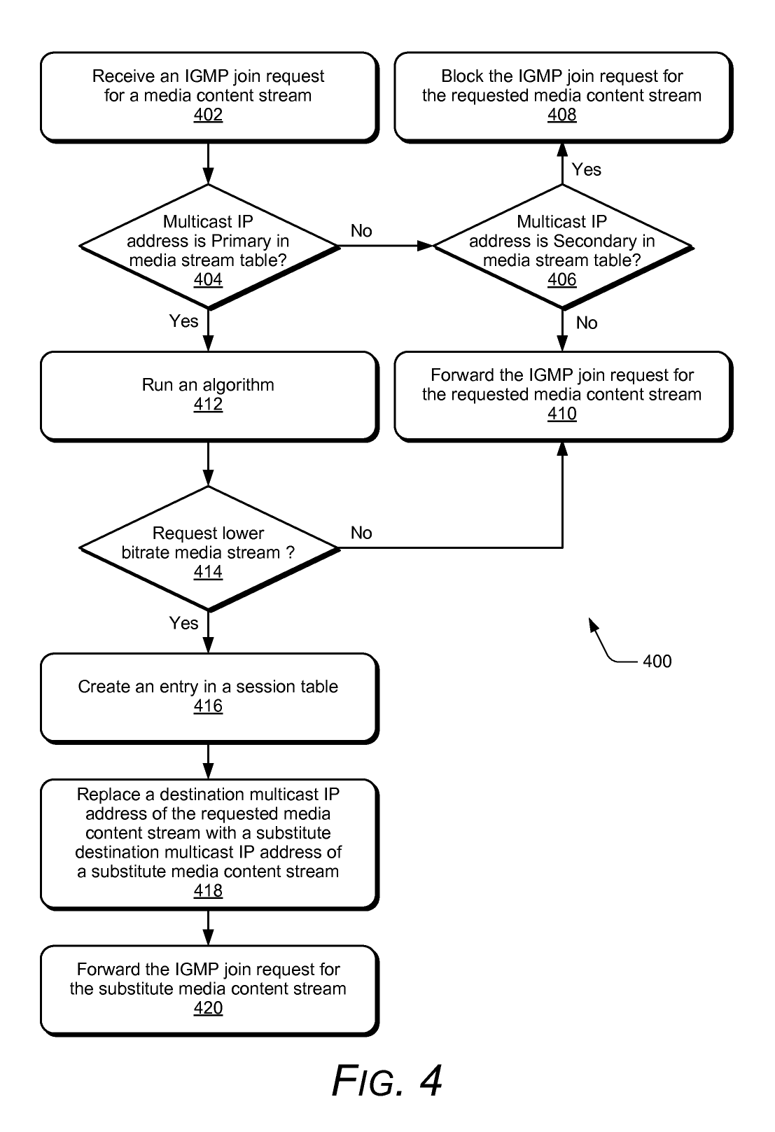

Example methods 300 and 400 are described with reference to respective FIGS. 3 and 4 in accordance with one or more embodiments of algorithmic media stream selection. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of algorithmic media stream selection, and is generally described with reference to a media stream manager implemented by a media routing device. The order in which the method blocks are described are not intended to be construed as a limitation, and any number or combination of the described method blocks can be combined in any order to implement a method, or an alternate method.

At block 302, a request for a media content stream is received from a media playback device. For example, the media routing device 120 (FIG. 1) receives a request for a media content stream 110 from the media playback device 122, such as an IGMP request to join an IP address that corresponds to the requested media content stream. At block 304, the requested media content stream is identified from a media stream reference list that indicates media content streams to be substituted. For example, the media stream manager 224 (FIG. 2) at the media routing device 120 identifies the requested media content stream 110 from the media stream table 126 that indicates media content streams to be substituted.

At block 306, a media stream selection algorithm is utilized to determine a system bitrate. For example, the media stream manager 224 at the media routing device 120 initiates the media stream selection algorithm 226 to determine whether to substitute the requested media content stream with a lower bitrate media content stream. The media stream selection algorithm 226 can be implemented based on any variable parameters of a media routing system, such as the available distribution bandwidth in a system that includes the media playback device, a size of a display of the media playback device, or a number of media content streams that are currently streaming to one or more media playback devices in the system.

At block 308, a substitute media content stream is selected for distribution to the media playback device based on one or more variable parameters. For example, the media stream manager 224 at the media routing device 120 selects the substitute media content stream 112, which may be selected from a group of substitute media content streams, for distribution to the media playback device 122 based on a lower bitrate of the substitute media content stream 112 than a bitrate of the requested media content stream 110. The requested media content stream 110 that has a bitrate of 5.0 Mbps (e.g., the primary stream of Service ID 1 shown in the media stream table 126) can be substituted with the substream of Service ID 1 (e.g., the substitute media content stream 112), which has a bitrate of 4.0 Mbps.

At block 310, a destination multicast IP address of the media content stream is replaced with a substitute destination multicast IP address that corresponds to the substitute media content stream and, at block 312, the substitute destination multicast IP address is forwarded to a content distributor to request the substitute media content stream. For example, the media stream manager 224 at the media routing device 120 replaces the destination multicast IP address of the requested media content stream 110 with a substitute destination multicast IP address that corresponds to the substitute media content stream 112, and forwards the substitute destination multicast IP address to the media content distribution system 102 as a request for the substitute media content stream.

At block 314, the substitute media content stream is received from the content distributor and, at block 316, the substitute media content stream is identified as the requested media content stream. For example, the media routing device 120 receives the substitute media content stream 112 from the media content distribution system 102, and the media stream manager 224 identifies the substitute media content stream 112 with the IP address that corresponds to the originally requested media content stream 110.

At block 318, the substitute media content stream is communicated to the media playback device for playback as the requested media content stream. For example, the media routing device 120 communicates the substitute media content stream 112 (e.g., as the media content segments 210 of the media content) that is identified with the destination multicast IP address of the requested media content stream 110 to the media playback device 122 for playback as the requested media content stream. From a perspective of the media playback device 122, the media content stream that was requested has been delivered according to the destination multicast IP address associated with the media content segments, even though the media playback device receives the substitute media content stream for playback.

FIG. 4 illustrates example method(s) 400 of algorithmic media stream selection, and is generally described with reference to a media stream manager implemented by a media routing device. The order in which the method blocks are described are not intended to be construed as a limitation, and any number or combination of the described method blocks can be combined in any order to implement a method, or an alternate method.

At block 402, an IGMP join request for a media content stream is received. For example, the media routing device 120 (FIG. 1) receives an IGMP join request for a media content stream 110 from the media playback device 122, such as a request to join an IP address that corresponds to the requested media content stream. This is also described with reference to block 302 (FIG. 3).

At block 404, a determination is made as to whether a multicast IP address of the requested media content stream is listed as a primary stream multicast IP address in a media stream table. For example, the media stream manager 224 (FIG. 2) at the media routing device 120 determines whether a multicast IP address of the requested media content stream 110 is listed in the media stream table 126 as a primary stream multicast IP address. If the requested media content stream is not listed as a primary stream multicast IP address in the media stream table (i.e., no from block 404), then at block 406, a determination is made as to whether the multicast IP address of the requested media content stream is listed as a secondary stream multicast IP address in a media stream table. For example, the media stream manager 224 at the media routing device 120 determines whether the multicast IP address of the requested media content stream 110 is listed in the media stream table 126 as a secondary stream multicast IP address.

If the requested media content stream is listed as a secondary stream multicast IP address in the media stream table (i.e., yes from block 406), then at block 408, the IGMP join request for the requested media content stream is blocked. For example, the media routing device 120 blocks the IGMP join request to avoid mixing translated and non-translated sessions to the same secondary media content stream. If the requested media content stream is not listed as a secondary stream multicast IP address in the media stream table (i.e., no from block 406), then at block 410, the IGMP join request for the requested media content stream is forwarded. For example, the media routing device 120 forwards the IGMP join request from the media playback device 122 to the media content distribution system 102 as a request for the media content stream 110.

If the requested media content stream is listed as a primary stream multicast IP address in the media stream table (i.e., yes from block 404), then at block 412, an algorithm is run (e.g., executed on a computing device). For example, the media stream manager 224 at the media routing device 120 initiates execution of the media stream selection algorithm 226 to determine whether to substitute the requested media content stream with a slower bitrate media content stream. This is also described with reference to block 306 (FIG. 3).

At block 414, a determination is made as to whether to request a lower bitrate media content stream. For example, the media stream manager 224 at the media routing device 120 determines whether to request a lower bitrate media content stream, such as the substream of Service ID 1 (e.g., the substitute media content stream 112), which has a bitrate of 4.0 Mbps as shown in the media stream table 126. The substream of Service ID 1 has a lower bitrate than the primary stream of Service ID 1, which has a bitrate of 5.0 Mbps. If a lower bitrate media content stream is not going to be requested (i.e., no from block 414), then the IGMP join request for the requested media content stream is forwarded at block 410.

If a lower bitrate media content stream is going to be requested (i.e., yes from block 414), then at block 416, an entry is created in a session table. For example, the media stream manager 224 at the media routing device 120 creates an entry in the session table 130 that correlates a particular client device (e.g., media playback device), as identified in the client device table 128, with the current media content stream, as identified in the media stream table 126.

At block 418, the destination multicast IP address of the requested media content stream is replaced with a destination multicast IP address of a substitute media content stream and, at block 420, the IGMP join request for the substitute media content stream is forwarded. For example, the media stream manager 224 at the media routing device 120 replaces the destination multicast IP address of the requested media content stream 110 with a substitute destination multicast IP address that corresponds to the substitute media content stream 112, and forwards the substitute destination multicast IP address to the media content distribution system 102 as a request for the substitute media content stream. This is also described with reference to blocks 310 and 312 (FIG. 3).

FIG. 5 illustrates various components of an example electronic device 500 that can be implemented as any device described with reference to any of the previous FIGS. 1-4. In embodiments, the electronic device may be implemented as a media content server, client device, media routing device, or media playback device, such as described with reference to FIGS. 1 and 2. Alternatively or in addition, the electronic device may be implemented in any form of device that can receive and playback streaming video content, such as any one or combination of a communication, computer, playback, gaming, entertainment, mobile phone, and/or tablet computing device.

The electronic device 500 includes communication transceivers 502 that enable wired and/or wireless communication of device data 504, such as received data, data that is being received, data scheduled for broadcast, data packets of the data, etc. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The electronic device 500 may also include one or more data input ports 506 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones and/or cameras.

The electronic device 500 includes one or more processors 508 (e.g., any of microprocessors, controllers, and the like) or a processor and memory system (e.g., implemented in an SoC), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 510. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 500 also includes one or more memory devices 512 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 500 may also include a mass storage media device.

A memory device 512 provides data storage mechanisms to store the device data 504, other types of information and/or data, and various device applications 514 (e.g., software applications). For example, an operating system 516 can be maintained as software instructions within a memory device and executed on the processors 508. The device applications may also include a device manager, such as any form of a control application, software application, signal-processing and control module, code that is native to a particular device, a hardware abstraction layer for a particular device, and so on. The electronic device may also include a media stream manager 518 and a media stream selection algorithm 520, such as when implemented as a media routing device.

The electronic device 500 also includes an audio and/or video processing system 522 that generates audio data for an audio system 524 and/or generates display data for a display system 526. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 528. In implementations, the audio system and/or the display system are integrated components of the example electronic device.

Although embodiments of algorithmic media stream selection have been described in language specific to features and/or methods, the subject of the appended claims is not necessarily limited to the specific features or methods described. Rather, the specific features and methods are disclosed as example implementations of algorithmic media stream selection.

1. A media routing device, comprising:
a content interface configured to receive media content from a content distributor and stream the media content to a media playback device;
a memory and processor system to implement a media stream manager that is configured to:
receive a request for a media content stream from the media playback device;
select a substitute media content stream for distribution to the media playback device based on one or more variable parameters;
forward the request to the content distributor for the substitute media content stream;
receive the substitute media content stream from the content distributor;
identify the substitute media content stream as the requested media content stream; and
communicate the substitute media content stream to the media playback device for playback as the requested media content stream.

2. The media routing device as recited in claim 1, wherein:
the media content is available from the content distributor as one of multicast IP or multicast listener discovery media streams;
the request for the media content stream from the media playback device is a request to join an IP multicast group that corresponds to the media content stream;
the media stream manager is configured to:
replace a destination multicast IP address of the media content stream with a substitute destination multicast IP address that corresponds to the substitute media content stream; and
forward the substitute destination multicast IP address as the request to the content distributor for the substitute media content stream.

3. The media routing device as recited in claim 2, wherein:
the media stream manager is configured to identify the substitute media content stream that is received from the content distributor with the destination multicast IP address that corresponds to the requested media content stream; and
communicate the substitute media content stream identified with the destination multicast IP address of the requested media content stream to the media playback device.

4. The media routing device as recited in claim 1, wherein the substitute media content stream has a lower bitrate than the requested media content stream, and wherein the media stream manager is configured to select the substitute media content stream for distribution to the media playback device based on the lower bitrate.

5. The media routing device as recited in claim 1, wherein the media stream manager is configured to:
identify the requested media content stream from a media stream reference list that indicates media content streams to be substituted; and
initiate a media stream selection algorithm that identifies the substitute media content stream for selection from a group of substitute media content streams.

6. The media routing device as recited in claim 1, wherein the variable parameters include available bandwidth, and wherein the media stream selection algorithm is utilized to determine a system bitrate from which to base selection of the substitute media content stream.

7. The media routing device as recited in claim 1, wherein the variable parameters include one or more of: available distribution bandwidth in a system that includes the media playback device, a size of a display of the media playback device, or a number of media content streams that are currently streaming to one or more media playback devices in the system.

8. A method, comprising:
receiving a request for a media content stream from a media playback device;
selecting a substitute media content stream for distribution to the media playback device based on one or more variable parameters;
forwarding the request to a content distributor for the substitute media content stream;
receiving the substitute media content stream from the content distributor;
identifying the substitute media content stream as the requested media content stream; and
communicating the substitute media content stream to the media playback device for playback as the requested media content stream.

9. The method as recited in claim 8, further comprising:
receiving the request for the media content stream as a request to join an IP multicast group that corresponds to the media content stream;
replacing a destination multicast IP address of the media content stream with a substitute destination multicast IP address that corresponds to the substitute media content stream; and
forwarding the substitute destination multicast IP address as the request to the content distributor for the substitute media content stream.

10. The method as recited in claim 9, further comprising:
identifying the substitute media content stream that is received from the content distributor with the destination multicast IP address that corresponds to the requested media content stream; and
communicate the substitute media content stream identified with the destination multicast IP address of the requested media content stream to the media playback device.

11. The method as recited in claim 8, wherein the substitute media content stream is selected for distribution to the media playback device based on a lower bitrate of the substitute media content stream than a bitrate of the requested media content stream.

12. The method as recited in claim 8, further comprising:
identifying the requested media content stream from a media stream reference list that indicates media content streams to be substituted; and
initiating a media stream selection algorithm that identifies the substitute media content stream for selection from a group of substitute media content streams.

13. The method as recited in claim 8, further comprising:
utilizing the media stream selection algorithm to determine a system bitrate from which to base selection of the substitute media content stream.

14. The method as recited in claim 8, wherein the variable parameters include one or more of: available distribution bandwidth in a system that includes the media playback device, a size of a display of the media playback device, or a number of media content streams that are currently streaming to one or more media playback devices in the system.

15. A media routing system, comprising:
one or more media playback devices each configured to receive and playback media content;
a media routing device configured to:
receive a request to join an IP multicast group that corresponds to a media content stream from a media playback device;
select a substitute media content stream for distribution to the media playback device based on one or more variable parameters;
replace a destination multicast IP address of the media content stream with a substitute destination multicast IP address that corresponds to the substitute media content stream;
forward the substitute destination multicast IP address as the request to a content distributor for the substitute media content stream;
identify the substitute media content stream that is received from the content distributor with the destination multicast IP address that corresponds to the requested media content stream; and
communicate the substitute media content stream identified with the destination multicast IP address of the requested media content stream to the media playback device.

16. The media routing system as recited in claim 15, wherein the substitute media content stream has a lower bitrate than the requested media content stream, and wherein the media routing device is configured to select the substitute media content stream for distribution to the media playback device based on the lower bitrate.

17. The media routing system as recited in claim 15, wherein the media routing device is configured to:
initiate a media stream selection algorithm that identifies the substitute media content stream for selection from a group of substitute media content streams.

18. The media routing system as recited in claim 17, wherein the variable parameters include available distribution bandwidth in the media routing system, and wherein the media stream selection algorithm is utilized to determine a system bitrate from which to base selection of the substitute media content stream.

19. The media routing system as recited in claim 15, wherein the variable parameters include one of: available distribution bandwidth in the media routing system, or a number of media content streams that are currently streaming to the one or more media playback devices.

20. The media routing system as recited in claim 15, wherein the media routing device is configured to:
receive a status query from the content distributor for playback status of the substitute media content stream;
update the status query with the destination multicast IP address that corresponds to the requested media content stream;
forward the updated status query to the media playback device;
receive a status report from the media playback device;
update the status report with the destination multicast IP address that corresponds to the substitute media content stream; and
forward the updated status report to the content distributor in response to the status query.
